(19) United States
(12) Patent Application Publication
(10) Pub. No.: US 2014/0041107 A1
(43) Pub. Date: Feb. 13, 2014

(54) FLAME-RESISTANT, HIGH VISIBILITY, ANTI-STATIC FABRIC AND APPAREL FORMED THEREFROM

(71) Applicants: Samuel D. Rose, Burlington, NC (US); Gary D. Zumstein, Mills River, NC (US); Tony L. Allen, Burnsville, NC (US)

(72) Inventors: Samuel D. Rose, Burlington, NC (US); Gary D. Zumstein, Mills River, NC (US); Tony L. Allen, Burnsville, NC (US)

(21) Appl. No.: 13/568,692

(22) Filed: Aug. 7, 2012

(51) Int. Cl. A62B 17/00; D03D 15/12; A41D 13/00; D03D 1/00

(52) U.S. Cl. 2/455; 428/221; 442/302; 442/304; 442/203

(57) ABSTRACT

A fabric for use in safety apparel comprising a first set of yarns comprising at least 60 percent modacrylic fibers, and a second set of yarns comprising at least some anti-static carbon filaments. The fabric meets at least the high visibility standard ANSI/ISEA-107-2010; the vertical flame test ASTM 1506-10w; and the Federal Test Method Standard 191A, Method 5931 for electrostatic decay, and the Electrostatic Discharge Association Advisory ADV11.2-1995 voltage potential.

### FIELD OF THE INVENTION

The present invention relates generally to fabric and safety apparel formed therefrom, and more particularly to fabric and apparel that, in addition to meeting nationally-recognized standards for conspicuity and flame-resistance, is anti-static.

### BACKGROUND OF THE INVENTION

Authorities worldwide have recognized the need to protect occupational workers from the inherent hazards of apparel that is deficient in contrast and visibility when worn by workers exposed to the hazards of low visibility. These hazards are further intensified by the often complex backgrounds found in many occupations such as traffic control, construction, equipment operation, and roadway maintenance. Of major concern is ensuring that these workers are recognized by motor vehicle drivers in sufficient time for the drivers to slow-down or take other preventive action to avoid hazard or injury to the workers. Thus, worker safety is jeopardized when clothing not designed to provide visual identification is worn by persons working in such dangerous environments. While there are no federal regulations governing the design, performance, or use of high-visibility apparel, local jurisdictions and private entities have undertaken to equip their employees with highly luminescent vests. One national standards organization, known as the American National Standards Institute (ANSI), in conjunction with the Safety Equipment Association (ISEA), has developed a standard and guidelines for high-visibility luminescent safety apparel based on classes of apparel.

Similarly, and in related fashion, certain of the above-mentioned occupations also require safety apparel that is flame resistant. For example, electric utility workers who may be exposed to flammable situations or to momentary electrical arc require apparel that is flame resistant and/or electric arc resistant. In the United States, there is a nationally-recognized standard providing a performance specification for flame resistant textile materials for safety apparel, referred to as the American Society for Testing and Materials (ASTM), standard F 1506. This standard provides performance properties for textile materials used in apparel that represent minimum requirements for worker protection. One component of this standard is the vertical flame test which measures whether an apparel will melt or drip when subjected to a flame, or continue to burn after the flame is removed. A second component of flame resistance is arc thermal performance, which is tested in accordance with ASTM standard F 1959-05 to meet acceptance criteria found in National Fire Prevention Association (NFPA) Standard 70E.

In recent years, utilities have become more diverse. Notably, electric utilities, for example, have diversified into the delivery of natural gas services. Thus, the same utility employees who provide electricity delivery services also service the natural gas network and facilities. This means that these employees not only require high visibility, and flame-resistance, but also require apparel that has anti-static properties suitable for wear in ignitable atmospheres.

Various items of safety apparel have been produced to meet one or the other of these nationally-recognized standards. Such items include those described in U.S. Pat. No. 6,706,650 to Gibson, et al; U.S. Pat. No. 6,946,412 to Campbell et al; U.S. Pat. No. 7,419,922 to Gibson et al., U.S. Pat. No. 6,787,228 to Campbell et al; U.S. Pat. No. 3,806,959 to Gross, U.S. Pat. No. 6,800,367 to Hanyon et al; and U.S. Published Application No. 2005/0208855 to Zhu.

Certain of these approaches which address anti-static concerns utilized wire or stainless steel fibers or filament combined in some form with the fire resistant fibers in the high visibility fabrics to provide anti-static capabilities. Applicants have now discovered stainless steel and wire, while dissipating static energy, have certain limitations. Exposed steel and wire surfaces are also subject to abrasion.

### SUMMARY OF THE INVENTION

Herein is described an improved fabric and apparel formed therefrom, that meets the minimum guidelines laid out in ANSI/ISEA-107-2010, “American National Standard for High-Visibility Safety Apparel”; the vertical flame test of ASTM F 1506-10a; Federal Test Method Standard 191A, Method 5931 (1990), “Determination of Electrostatic Decay of Fabrics”; and the Electrostatic Discharge Association advisory ESD ADV11.2-1995, “Triboelectric Charge Accumulation Testing”. In addition, certain embodiments will meet the minimum guidelines of “Standard Performance Specification for Flame Resistant Textile Materials for Wearing Apparel for Use by Electrical Workers Exposed to Momentary Electric Arc and Related Thermal Hazards” of ASTM F 1959-05.

ANSI/ISEA-107-2010 specifies requirements for apparel capable of signaling the wearer's presence visually and intended to provide conspicuity of the wearer in hazardous situations under any light conditions by day, and under illumination by vehicle headlights in darkness. As used herein, and as defined in ANSI/ISEA-107, “conspicuity” refers to the characteristics of an object which determine the likelihood that it will come to the attention of an observer, especially in a complex environment which has competing foreground and background objects. Conspicuity is enhanced by high contrast between the clothing and the background against which it is seen. The ANSI standard specifies performance requirements for color, luminance, and reflective area. Three different colors for background and combined performance are defined in the standard. The color selected should provide the maximum contrast with the anticipated background for use of the apparel. Several combinations are described in the standard depending upon the intended use. For example, the ANSI standard describes three classes of conspicuity. For utility workers, the apparel should meet either Class 2 or Class 3.

ASTM F 1506 provides a performance specification that may be used to evaluate the properties of fabrics or materials in response to heat and flame under controlled laboratory conditions. For exposure to an open flame, a fabric or apparel must not melt, drip, or continue to burn after the flame is removed. The properties of material for basic protection level wearing apparel should conform to the minimum requirements for woven or knitted fabrics with respect to breaking load, tear resistance, seam slippage, colorfastness, flammability before and after laundering, and arc testing. ASTM F 1506 specifies these performance characteristics based on fabric weight ranges, expressed in ounces per square yard. ASTM F 1506 also establishes that an after flame may not persist for more than 6 seconds when subjected to the arc testing of ASTM F 1959-05.

With respect to determining the anti-static properties of a fabric, there are several generally recognized test methods known in the art. While there is no one specific test for measuring electrostatic charge accumulation, two known methods provide some assurance that a fabric is electrostatically safe. Federal Test Method Standard 191A, Method 5931, Determination of Electrostatic Decay of Fabrics, which is incorporated herein in its entirety, provides a method for determining the time required for a charge on a fabric surface to decay to an electrostatically safe level. This test method is appropriate for use on material which may or may not contain conductive fibers or which has been treated with an anti-static finish. The primary purpose of the test is to determine whether a fabric is safe for wear during electrostatic sensitive operations. Specifically, the test method measures the amount of time, in seconds, for the static imparted to a fabric to decay from 5,000 Volts to 500 Volts. Safe is considered to be a time less than 0.5 seconds.

The Electrostatic Discharge Association Advisory For Protection of Electrostatic Discharge Susceptible Items-Triboelectric Charge Accumulation Testing, ESD ADV 11.2-1995 also provides a summary of tribocharging theory and test methods. The test methods contained in the Advisory have been designed to predict which materials will charge to what level and polarity when contacted with a given material. The vest is worn by a technician over a cotton shirt in a humidity controlled room. The field potential of the vest while being worn, as it is removed, and after it is removed is measured by a mill type electrostatic field meter. The potential of the hand of the technician is measured by a charge plate monitor while the vest is being worn and while it was being held after it was removed. In accordance with National Fire Protection Association Standard NFPA 77-2000, Recommended Practice on StaticElectricity, potentials of greater than 1,500 volts are considered hazardous in ignitable areas.

The rigorous performance specifications of each of the above test methods are met by the fabric and safety apparel formed from the unique yarns of the present invention. A fabric is formed primarily from a first yarn that includes modacrylic and a small amount of a second, anti-static yarn. The second yarn is formed of an end having filaments or fibers of a carbon, preferably a carbon core encased in a polymeric sheath twisted with at least one end of another yarn. The second yarn is introduced at spaced intervals in the warp and fill of a woven fabric or in spaced courses of a knit fabric. The resulting fabric will meet all the requirements for fire resistance and anti-static standards. Then, when dyed appropriately, the fabric will meet the ANSI-107-2010 standards.

Modacrylics have characteristics that solve two problems addressed by the present invention. First, modacrylic yarns are inherently flame resistant, with the level of flame resistance varying based upon the weight percentage of acrylonitriles in the composition. Secondly, modacrylic yarns are very receptive to cationic dyes, which are known for their brilliance.

Applicants have determined that an improved fire resistant, hi-visibility fabric and garment with static dissipative properties may be produced by introducing a carbon end at spaced intervals as the conductive element in a second yarn rather than stainless steel or other wire fibers. This carbon element may be produced by spun carbon fibers, or by a plurality of carbon filaments combined to form an end which may be introduced alone or by twisting it with another end of more conventional yarn to form a twisted yarn. The carbon containing yarn is introduced in spaced ends/picks in the warp and fill of a woven fabric. Such a yarn could also be introduced in spaced warp threads or courses in a knit fabric to achieve this anti-static effect. To satisfy the anti-static standards described herein, the inventors have found that the weight of the anti-static (carbon) component should be between 0.5 percent and 5 percent of the total fabric weight, with a preferred amount of about 1 percent.

Aramid fibers are manufactured fibers in which the fiber-forming material is a long chain synthetic polyamide having at least 85 percent of its amide linkages (—NH—CO—) attached directly to two aromatic rings. Poly-para-phenylene terephthalamide is one such aramid which is produced from long molecular chains that are highly oriented with strong interactive bonding. When blended with the modacrylic fibers, the high tensile strength and high energy absorption properties of these materials contribute to even higher values for thermal performance and resistance to breakopen (formation of holes) when subjected to high energy. As used herein, and as well known in the art, the term “aramid” includes “meta-aramids” such as Nomex® and Conex™, and “para-aramids” such as Kevlar® and Technora®. Aramid fibers, included both meta-aramids and para-aramids, are only preferred examples of a “high energy absorbing” fiber. The term “high energy absorbing,” as used herein, means that such fibers, when blended with other fibers will cause the resulting fabrics to meet or exceed the minimum arc thermal performance value of 4.0 cal/cm² or Category 1 as established by the NFPA 70E using the ASTM F 1959-05 test method. Other fibers that could be used as “high energy absorbing” fibers include polybenzimidazole (PBI) fibers, polybenzoxazole (PBO) fibers, polyamide-imide fibers, polysulfonamide (PSA) fibers, rayon, lyocell, and the like, and blends thereof.

In one exemplary embodiment, fabric constructed according to the present invention is formed from two types of yarns. One yarn type, also referred herein as “body yarn”, since it forms substantially the main body of the fabric, is formed substantially from modacrylic fibers, or a blend of primarily modacrylic fibers and high energy absorbing fibers such as aramids, rayon, or other fibers that are spun in accordance with conventionally known techniques. It is also possible to blend a minor amount of other fibers such as cotton, nylon, polyester, or the like with the modacrylic fibers along with the energy absorbing fibers. It has been found that fabrics formed from such blended yarns, wherein the modacrylic fibers used to form the yarns provide a flame-resistance rating that meets at least the vertical flame burn test minimum criteria for safety apparel. The blended energy absorbing fibers provide additional strength and sufficient energy absorption to meet the arc testing standards of NFPA-70E. The second yarn type, also referred herein as the “anti-static yarn”, comprises an end of conductive anti-static carbon fibers or filaments. The end of conductive fibers or filaments may be used alone, however may also be a combination of an end of modacrylic fibers (or other fibers) and another end of conductive anti-static carbon fiber or filament, the two ends twisted together. It has been found that polymeric encased carbon core filaments such as Nega-Stat® by W. Barnet & Son, LLC of Arcadia, S.C. blended with modacrylic fibers provide suitable electrostatic discharge and low voltage potentials. In one preferred embodiment, the second yarn comprises about 20 percent Nega-Stat® and about 80 percent modacrylic filament. As constructed, the first yarn type makes up at least about 85-90 percent by weight of the fabric. The fabric may be either woven or knit. The inherently flame resistant material is dyed in conventional fashion in a jet dye machine with cationic, or basic, dyestuff compositions to obtain International Yellow or International Orange hues that will meet the luminescence and chromacity requirements of ANSI/ISEA-107-2010.

According to another exemplary embodiment, the first yarn has no aramid, rayon, or energy absorbing fibers, because in some environments there is no need for the energy absorbing characteristic. In this fabric the first yarn is all or primarily modacrylic, but a minor amount of other fibers may be used. The second yarn can be the same as the second yarn previously described for the first exemplary embodiment.

In an exemplary woven fabric the second yarn is introduced at spaced intervals (about 10 mm) in the warp and fill, although the spacing can vary. The concept may also be applied to knits.

In an exemplary warp knit fabric, the second yarn is introduced at spaced intervals across the warp beam, for example one second yarn every 11 yarns, although again that spacing may vary.

While the exemplary embodiments described herein are formed from a first yarn comprising an intimate blend of modacrylic and high performance, high energy absorptive fibers, and a second yarn formed by twisting a modacrylic end with an end comprising filaments of the polymeric encased carbon filament, the yarn and fabric constructions are not limited thereto.

These and other aspects of the present invention will become apparent to those skilled in the art after a reading of the following description of the preferred embodiment.

### DESCRIPTION OF THE PREFERRED EMBODIMENT

Having described the industry standards that provide the acceptance criteria for basic protection levels for occupational workers, the fabric, and apparel formed therefrom, of the present invention is formed from a two types of yarn that each comprise a combination of materials that will meet each of the standards.

In one embodiment, the fabric construction comprises two types of yarns. One yarn type (the body yarn) is formed primarily from modacrylic fibers; however it may comprise a blend comprising at least about 60 percent to 97 percent modacrylic fibers, combined with at least about 3 percent to 30 percent high energy absorptive fibers. So long as the blend contains at least 60 percent modacrylic and 3 percent high energy absorptive fibers, up to 37 percent of the yarn may be of other fibers, so long as they are compatible with the FR HI VIS requirements. The second yarn type (the anti-static or conductive yarn) is a combination of a primarily modacrylic end and an end of anti-static filaments formed of a carbon core preferably encased in a polymeric sheath. The modacrylic end and the anti-static filament are twisted together. Again, as long as the primarily modacrylic end contains at least 60 percent modacrylic, other fiber may be added. In this embodiment, the anti-static fibers preferably comprise a continuous carbon filament encased in a polyester sheath but other conductive yarns (not steel) with or without encasing polymers may be used, so long as they suitably dissipate the electric charge.

In a second embodiment the first yarn is 100 percent modacrylic fiber or a blend of at least 60 percent modacrylic fibers and up to 40 percent of other fibers that would be compatible with the FR Hi Vis requirements, such natural fibers like cotton or wool, or other fibers such as polyester, nylon, rayon, or other polymeric fibers. Again, the second yarn would include one end of at least 60 percent modacrylic fibers. So long as the blend contains at least 60 percent modacrylic, up to 40 percent of the total blend may be other fibers, so long as they are compatible with the FR Hi Vis requirements. The other end of the second yarn would again be the anti-static filaments, each formed of a carbon core encased in a polymeric sheath. The two ends would be twisted together. As earlier discussed the carbon core/polymeric sheath ends are preferred, but this end could also be spun or filamentary carbon alone.

Modacrylics are polymers that have between 35 percent and 85 percent acrylonitrile units, modified by other chemical modifiers such as vinyl chloride. All modacrylics have a flame-resistant character to some extent, however, it has been found that fabrics formed from modacrylic yarns having at least about 50 percent by weight of acrylonitrile units will provide excellent flame resistance. That is, they will not melt and drip, or continue to burn when a source of ignition is removed. Although other modacrylic fibers could be used to form the yarn and fabric of the present invention, the yarn and fabric of the present invention is formed from short staple fibers of Kanecaron® SYS. Kanecaron® SYS is a 1.7 denier, 2 inch modacrylic staple fiber manufactured by Kaneka Corporation, Osaka, Japan. Kanecaron® Kanecaron SYS fiber has a tenacity of about 3 grams/denier, a Young's Modulus of about 270 kg/mm², a dull luster, and has been found to meet the structural requirements of both ANSI/ISEA-107-2010 and ASTM F 1506. Modacrylic fibers having tenacities of at least about 2 grams/denier are also suitable to form the yarn and fabric of the present invention.

In some embodiments, the first or body yarn having the energy absorbing properties is formed by modacrylic staple fibers blended with long moledular chain fibers produced from poly-paraphenylene terephthalamide, a para-aramid commonly available from DuPont under the trademark Kevlar®, or available from Teijin Limited of Osaka, Japan under the trademark Technora®. These aramid fibers provide suitable fire resistance, strength, and energy absorption and tenacities greater than about 20 grams/denier.

In other embodiments of that same type of body yarn, it has been found that yarns formed of modacrylic fibers blended with meta-aramid fibers commonly available from DuPont under the trademark Nomex®, or from Teijin Limited under the label Conex™ also provide quite suitable fire-resistance, strength, and energy absorption. These fibers have tenacities greater than about 4 grams/denier.

In the embodiments described above, para-aramids and meta-aramids provide the energy absorbing properties, however other energy absorbing fibers such as FR rayon, and even rayon have been found to absorb sufficient energy to meet the arc performance standards of ASTM F 1959.

While yarns of the first type, the body yarns, according to the present invention, may incorporate a major amount of other fibers, they require at least about 60 percent modacrylic fibers and at least about 3 percent aramid fibers when blended with one of the aforementioned energy absorptive materials in order for the resulting fabric to meet the ANSI, ASTM, and NFPA standards described above. Preferably, fabric with blends containing about 95 percent of the modacrylic fibers and about 5 percent of the high energy absorptive fibers provides the most acceptable results.

In the second, or anti-static yarn, other yarns, which are preferably formed from modacrylic staple fibers are combined with anti-static fibers. In such case the second, or anti-static yarn, as previously described is a combination of a primarily modacrylic yarn end (although a minor amount of the other fibers may be blended with the modacrylic) and an end formed of carbon fibers or filaments, preferably a carbon core with a polyester sheath. One such type of filament is formed with a trilobally shaped carbon core surrounded by a polyester sheath. It is identified by the trademark Nega-State and is available from W. Barnet & Son, LLC of Arcadia, S.C. The conducting core neutralizes surfaces charges by induction and dissipates the charge by airionisation (Corona-discharge). It has been found that this type of anti-static yarn will meet Federal Test Method Standard 191A, Method 5931, yet does not build up charge and spark. Further it has proven easier to fabricate, has a longer life, and provides more reliable continuity. Because of this construction, the total carbon content of the fabric will be 0.5-5 percent by weight.

The process for making fabric according to the present invention, using the materials described above, is discussed in detail below.

### The Process

As described above, the polyester encased carbon core yarn, i.e., is available from W. Barnet & Son, LLC. In one preferred embodiment, that yarn is a multi-filament yarn available in den. 35f6, den. 70f12, and den 140f24; however, the yarn construction is not limited thereto. With respect to the first yarn type construction, as is conventional in short staple yarn manufacture, bales of short staple fibers, in the percentages of modacrylic and Technora® para-aramid fibers described above, are initially subjected to an opening process whereby the compacted fibers are “pulled” or “plucked” in preparation for carding. Opening serves to promote cleaning, and intimate blending of fibers in a uniform mixture, during the yarn formation process. Those skilled in the art will appreciate that there are a number of conventional hoppers and fine openers that are acceptable for this process. The open and blended fibers are next carded using Marzoli CX300 Cards to form card slivers. The card slivers are transformed into drawing slivers through a drawing process utilizing a process known as breaker drawing on a Rieter SB951 Drawframe and finisher drawing on a Rieter RSB951 Drawframe. Drawn slivers are next subjected to a Roving process conventionally known in preparation for Ring Spinning. A Saco-Lowell Rovematic Roving Frame with Suessen Drafting is used to twist, lay and wind the sliver into roving. A Marzoli NSF2/L Spinning Frame is used to ring spun the yarn product. Winding, doubling, and twisting processes conventionally known in the art are used in completing the yarn product. A finished yarn found structurally suitable for the present invention is an 18 singles, 2-ply construction.

An end of modacrylic yarn is also twisted together with the Nega-Stat® conductive end (den. 35f6) to form the second yarn.

The illustrated fabrics are woven and knit and include para-aramid fibers to meet the arc testing requirements; however, other constructions, without the para-aramid fibers may be used, provided they meet the design and structural requirements of the two standards. Additionally, it has been found that up to about 40 percent of the total fabric (woven or knit) weight may comprise other synthetic materials, such as polyester, nylon, etc.

### Woven Fabric

One exemplary fabric is woven (plain weave) on a Picanol air jet loom with 36 warp ends and 33 fill ends of yarn per inch and an off-loom width of 71 inches. In a preferred embodiment, after every 13 ends (picks) of the body yarn in the fill direction, one pick of anti-static fiber is woven in. In the warp direction, again one end of anti-static yarn is woven in after every 13 ends of body yarn. This creates an anti-static grid of about 10 mm and is approximately square, after finishing of the fabric; however smaller and larger grid sizes will also provide suitable results. It has been found by the inventors that the anti-static yarns must be woven in both the warp and fill directions to obtain these grids to provide suitable static decay and acceptable potential voltages. Any looms capable of weaving modacrylic yarns may just as suitably be used. The woven fabric has a desired weight of approximately 4 to 20 ounces per square yard, and desirably about 6.5 ounces per square yard as necessary to satisfy the design requirements for the particular class of safety apparel.

### Knit Fabric

Another exemplary fabric is knit on a Raschel warp knitting machine using a combination of (1) a first yarn end (24/1's) formed of 88% modacrylic and 12% Kevlar fiber blended together and (2) a Nega-Stat® conductive end (den 70f12) which forms a second yarn. The first yarns are set up on the top bar of a Raschel machine and the second yarns are set up on the bottom bar. Ten ends of the modacrylic/Kevlar blended yarns are introduced for each Nega-Stat® yarn. This results in 27-28 yarns per inch and the Nega-Stat® ends about a centimeter apart. Other types of knitting machines capable of providing a conductive yarn include Tricot and circular.

In preparation for dyeing, both the woven and/or the knit fabric is subjected to desizing and scouring to remove impurities and sizes such as polyacrylic acid. The process of desizing is well known in the art. A non-ionic agent is applied in a bath at between about 0.2 and 0.5 weight percent of the fabric and an oxidation desizing agent is applied in a bath at about 2 to 3 percent of fabric weight. The use of such agents is well known in the art. The processing, or run, time for desizing and scouring is approximately 15 to 20 minutes at 60° C. The fabric is then rinsed with water at a temperature of 60° C.

The pretreated fabric is then ready for dyeing and finishing. The dyeing is formed in a jet dye machine such as a Model Mark IV manufactured by Gaston County Machine Company of Stanley, N.C. The specific dyes used to color the fabric of the present invention are basic, or cationic, dyestuffs. The cationic dyes are known for their acceptability in dyeing polyesters, nylons, acrylics, and modacrylics. However, it has heretofor not been known that these dyes could be formulated to dye modacrylic material in order to meet the luminance and chromacity criteria for safety apparel according to ANSI/ISEA-107-2010 and the fire resistant criteria of ASTM F 1506. Two dye formulations have been found to meet the high visibility criteria for ANSI/ISEA-107-2010. A dye formulation for International Yellow comprises basic Flavine Yellow, available from Huntsman Textile Effects of High Point, N.C. as product MELACRYL FLAVINE. It has been found that this dyestuff applied at between about 2 to 2½ percent of fabric weight successfully achieves the ANSI criteria. A dye formulation for International Orange may be formed from Yellow and Red cationic dyestuffs. The yellow is available from Huntsman, as above, and the red is MELACRYL RED AG from Melatex, Inc. in Charlotte, N.C. The red and yellow are mixed at percentages sufficient to meet the ANSI/ISEA-107-2010 shade requirements (approximately 76% yellow and 23% red).

Either of the dyestuffs described above are added to the jet dye machine. The Ph of the bath is established at between about 3 and 4, with acid used to adjust the Ph as required. The bath temperature in the jet dyer is raised at about 1° C. per minute to a temperature of about 80° C., where the temperature is held for approximately 10 minutes. The temperature is then raised approximately 0.5° C. per minute to a temperature of 98° C. and held for approximately 60 minutes. The bath is then cooled at about 2° C. per minute to 60° C. At that point, the bath is emptied and rinsing with water at 60° C. occurs until the dye stuff residue in the jet dyer is removed. At this point, the dyeing cycle is complete. Wet fabric is removed from the dye machine where it is dried on a standard propane open width tenter frame running at approximately 40 yards per minute at approximately 280° F. to stabilize width and shrinkage performance. At the completion of this process, a fabric that meets the ANSI standard for high visibility safety apparel, the ASTM standard for flame resistance, the fabric construction also meets the Federal Test Method Standard 191A, Method 5931 for electrostatic decay, and the ESD ADV11.2-1995 standard for voltage potential.

Samples of both the woven and the knit fabrics were subjected to testing for conspicuity, arc thermal, and static decay. The woven samples passed both ANSI-107-2010 for conspicuity, Federal Test Method 191A, Method 5931 for static decay, ASTM F 1506-10a for flame resistance, and ASTM F 1959-05 (6.4 cal/cm²) for arc rating. The knit samples passed ANSI 107-2010; ASTM 6413 for flame resistance; NFPA 70-E for arc rating; and EN1149 for static decay.

The finished fabric may be used to construct an unlimited number of types of safety apparel. The most common types are shirts or vests, and trousers or coveralls. The final constructed garments are designed and formed to meet the design, structural, and fastening criteria of the ANSI and ASTM standards.

Certain modifications and improvements will occur to those skilled in the art upon a reading of the foregoing description. For example the second yarn can be the anti-static filament alone, where the weaving or knitting equipment is capable of handling such. Further the second yarn can be carbon fibers spun into a yarn or blended with other fibers and spun into a yarn form. It should be understood that all such modifications and improvements have been deleted herein for the sake of conciseness and readability but are properly within the scope of the following claims.

We claim:

1. A fabric for use in safety apparel, comprising:
(a) a first set of yarns comprising at least 60 percent modacrylic fibers;
(b) a second set of yarns including anti-static carbon ends;
(c) yarns from the second set being a minority of the yarns in the fabric and introduced in spaced intervals in the fabric along with yarns from the first set;
(d) the fabric having a dye applied thereto that meets the America National Standard Institute standard ANSI/ISEA-107-2010 minimum conspicuity level class requirements for occupational activities for high-visibility safety apparel;
(e) wherein, the fabric also meets the Federal Test Method Standard 191A, Method 5931 for electrostatic decay, the Electrostatic Discharge Association Advisory ADV11.2-1995 voltage potential, and the vertical flame test of ASTM F 1506-10a (2000).

2. The fabric of claim 1 wherein yarns of the second set are formed of at least one end of the anti-static filaments twisted with at least one end of another yarn; the end of another yarn comprising at least 60 percent modacrylic fibers.

3. The fabric of claim 1 wherein the anti-static carbon filaments of the second yarn set comprise a trilobally shaped carbon core surrounded by a polyester sheath.

4. The fabric of claim 1 wherein the first set of yarns further comprise a minor amount of high energy absorptive fibers sufficient to meet the arc thermal performance standards of ASTM F 1959-05.

5. The fabric of claim 1 wherein the weight of the carbon content compared to the weight of the fabric overall is between 0.5 and 5 percent.

6. The fabric of claim 1 wherein the first set of yarns comprise at least about 85 percent of the fabric.

7. The fabric of claim 4 wherein the modacrylic fibers and said high energy absorptive fibers are intimately blended staple fibers.

8. The fabric of claim 1 wherein the fabric is woven.

9. The fabric of claim 1 wherein the fabric is knit.

10. The fabric of claim 4 wherein the first set of yarns comprises at least 70 percent modacrylic fibers and at least 3 percent high energy absorptive fibers.

11. The fabric of claim 2 wherein said modacrylic fibers contain at least 50 percent acrylonitrile.

12. The fabric of claim 4 wherein the high energy absorptive fibers are aramid.

13. The fabric of claim 12 wherein the aramid is formed from poly-paraphenylene terephthalamide.

14. The fabric of claim 4 wherein the high energy absorptive fibers are selected from the group of fibers consisting of meta-aramids and para-aramids.

15. The fabric of claim 4 wherein said high energy absorptive fibers have a tenacity of at least about 4 grams/denier.

16. The fabric of claim 8 wherein said woven fabric comprises anti-static fibers in both the warp and fill directions.

17. The fabric of claim 1 where in the first body yarn is selected from the group consisting of modacrylic and yarns comprising an intimate blend of modacrylic fibers and fibers selected from the group consisting of polyester, nylon, rayon, cotton, wool, and combinations thereof.

18. The fabric of claim 1 wherein the fabric comprises at least about 0.5 percent carbon by weight.

19. The fabric of claim 4 wherein the carbon makes up between about 0.5 percent and 5 percent of the fabric by weight.

20. The fabric of claim 16 wherein yarn type comprising the anti-static fibers occurs at least about every 10 millimeters in the warp and at least about every 10 millimeters in the weft, thereby forming a grid.

21. A safety garment having high visibility and flame resistant characteristics formed from:
(a) a fabric comprising a first set of yarns and a second set of yarns;
(b) a first set of yarns comprising at least 60 percent modacrylic fibers;
(c) a second set of yarns including anti-static carbon ends;
(d) yarns from the second set being a minority of the yarns in the fabric and introduced in spaced intervals in the fabric along with yarns from the first set;
(e) the fabric having a dye applied thereto that meets the America National Standard Institute standard ANSI/ISEA-107-2010 minimum conspicuity level class requirements for occupational activities for high-visibility safety apparel;
(f) wherein, the fabric also meets the Federal Test Method Standard 191A, Method 5931 for electrostatic decay, the Electrostatic Discharge Association Advisory ADV11.2-1995 voltage potential, and the vertical flame test of ASTM F 1506-10a (2000).

22. The safety garment of claim 21 wherein yarns of the second set are formed of at least one end of the anti-static filaments twisted with at least one end of another yarn; the end of another yarn comprising at least 60 percent modacrylic fibers.

23. The safety garment of claim 21 wherein the anti-static carbon filaments of the second yarn set comprise a trilobally shaped carbon core surrounded by a polyester sheath.

24. The safety garment of claim 21 wherein the first set of yarns further comprise a minor amount of high energy absorptive fibers sufficient to meet the arc thermal performance standards of ASTM F 1959-05.

25. The safety garment of claim 23 wherein the weight of the carbon content compared to the weight of the fabric overall is between 0.5 and 5 percent.

26. The safety garment of claim 20 wherein the fabric is woven.

27. The safety garment of claim 20 wherein the fabric is knit.

28. The safety garment of claim 24 wherein the first set of yarns comprises at least about 70 percent modacrylic fibers and at least about 3 percent high energy absorptive fibers.

29. The safety garment of claim 22 wherein said modacrylic fibers contain at least 50 percent acrylonitrile.

30. The safety garment of claim 24 wherein the high energy absorptive fibers are aramid.

31. The safety garment of claim 30 wherein the aramid is formed from poly-paraphenylene terephthalamide.

32. The safety garment of claim 30 wherein the high energy absorptive fibers are selected from the group of fibers consisting of meta-aramids and para-aramids.

33. The safety garment of claim 24 wherein said high energy absorptive fibers have a tenacity of at least about 4 grams/denier.

34. The safety garment of claim 26 wherein said woven fabric comprises anti-static fibers in both the warp and fill directions.
